(19) United States
(12) Patent Application Publication
(10) Pub. No.: US 2026/0320279 A1
(43) Pub. Date: Oct. 15, 2026

(54) INFORMATION PROCESSING METHOD, APPARATUS, ELECTRONIC DEVICE, STORAGE MEDIUM, AND PROGRAM PRODUCT

(71) Applicant: Beijing Zitiao Network Technology Co., Ltd., Beijing (CN)

(72) Inventors: Tao XIAO, Beijing (CN); Tao YU, Beijing (CN); Tong ZOU, Beijing (CN); Wei ZENG, Beijing (CN)

(21) Appl. No.: 19/646,503

(22) Filed: Apr. 13, 2026

(30) Foreign Application Priority Data
Apr. 14, 2025 (CN) 202510466367.0

(51) Int. Cl. G06F 40/103; H04N 21/431

(52) U.S. Cl. CPC G06F 40/103; H04N 21/4312

(57) ABSTRACT

The present disclosure relates to an information processing method, an apparatus, an electronic device, a storage medium, and a program product, and relates to the field of computer technologies. The information processing method of the present disclosure includes: obtaining a to-be-displayed character string corresponding to a currently configured text view in a user interface; determining size information of the to-be-displayed character string; and determining whether to trigger a relayout of the text view based on the size information of the to-be-displayed character string, size information of a character string displayed last time in the text view, and a size tolerance of the text view.

### CROSS-REFERENCE TO RELATED APPLICATIONS

This application claims the benefit under 35 USC 119(a) of Chinese Patent Application No. 202510466367.0, filed on Apr. 14, 2025. The entire disclosure of the prior application is hereby incorporated by reference in its entirety.

### TECHNICAL FIELD

The present disclosure relates to the field of computer technologies, and in particular, to an information processing method and apparatus, an electronic device, a storage medium, and a program product.

### BACKGROUND

The role of a text view is very important in a user interface (UI) design. The text view may be used to display text, and is very frequently used and will be frequently updated in many scenarios. For example, in a live broadcast scenario, related text content such as the number of likes, the number of new messages, and the number of viewers on the user interface will be frequently updated, which leads to frequent updates of the text view.

A dynamic change in text content often requires an immediate adjustment to a text view size, to maintain the aesthetics and functionality of the layout. In the related art, once the text content is configured, a relayout of the text view is triggered, which may further lead to a relayout of views in an entire view tree related to the text view.

### SUMMARY

According to some embodiments of the present disclosure, there is provided an information processing method, including: obtaining a to-be-displayed character string corresponding to a currently configured text view in a user interface; determining size information of the to-be-displayed character string; and determining whether to trigger a relayout of the text view based on the size information of the to-be-displayed character string, size information of a character string displayed last time in the text view, and a size tolerance of the text view.

According to some other embodiments of the present disclosure, there is provided an information processing apparatus, including: an obtaining module configured to obtain a to-be-displayed character string corresponding to a currently configured text view in a user interface; a size determination module configured to determine size information of the to-be-displayed character string; and a layout determination module configured to determine whether to trigger a relayout of the text view based on the size information of the to-be-displayed character string, size information of a character string displayed last time in the text view, and a size tolerance of the text view.

According to some yet other embodiments of the present disclosure, there is provided an electronic device, including: a processor; and a memory coupled to the processor and configured to store instructions, where the instructions, when executed by the processor, cause the processor to perform the information processing method according to any one of the embodiments of the present disclosure.

According to some still other embodiments of the present disclosure, there is provided a computer-readable storage medium having a computer program stored thereon, where the computer program, when executed by a processor, causes the processor to perform the information processing method according to any one of the embodiments of the present disclosure.

Other features, aspects, and advantages of the present disclosure become apparent with reference to the following detailed description of the embodiments of the present disclosure.

### BRIEF DESCRIPTION OF THE DRAWINGS

Embodiments of the present disclosure are described below with reference to the drawings. It should be understood that the drawings in the following description relate to only some embodiments of the present disclosure, and do not constitute a limitation on the present disclosure. In the drawings:

FIG. 1 is a schematic flowchart of an information processing method according to some embodiments of the present disclosure;

FIG. 2 is a schematic diagram of a display interface according to some embodiments of the present disclosure;

FIG. 3 is a schematic flowchart of an information processing method according to some other embodiments of the present disclosure;

FIG. 4 is a schematic diagram illustrating the structure of an information processing apparatus according to some embodiments of the present disclosure;

FIG. 5 is a schematic diagram illustrating the structure of an electronic device according to some embodiments of the present disclosure;

FIG. 6 is a schematic diagram illustrating the structure of an electronic device according to some other embodiments of the present disclosure.

### DETAILED DESCRIPTION

The technical solutions in the embodiments of the present disclosure are clearly and completely described below with reference to the drawings in the embodiments of the present disclosure. It should be understood that the present disclosure may be implemented in various forms, and should not be construed as being limited to the embodiments set forth herein.

It should be understood that steps described in method implementations of the present disclosure may be performed in different orders and/or in parallel. Furthermore, the method implementations may include additional steps and/or omit performing the illustrated steps. The scope of the present disclosure is not limited in this respect. Unless otherwise specifically stated, relative arrangements of the steps set forth in these embodiments should be construed as being merely exemplary, and do not limit the scope of the present disclosure.

The term "include/comprise" and variations thereof used in the present disclosure are open-ended terms that mean "include/comprise at least the following elements/features, but do not exclude other elements/features", that is, "include/comprise but not limited to". The term "based on" means "at least partially based on".

It should be noted that modifications of "one" and "a plurality of" mentioned in the present disclosure are illustrative rather than restrictive, and those skilled in the art should understand that unless otherwise clearly specified in the context, the modifications should be construed as "one or more".

The embodiments of the present disclosure are described in detail below with reference to the drawings, but the present disclosure is not limited to these specific embodiments. The following specific embodiments may be combined with each other, and the same or similar concepts or processes may not be described in detail in some embodiments. In addition, in one or more embodiments, a specific feature, structure, or characteristic may be combined in any suitable manner that will be clear to those of ordinary skill in the art from the present disclosure.

In many application scenarios, text in a text view is frequently configured and updated. If an attribute value of a size setting of the text view is configured as an attribute of automatic adjustment, once text content is configured, a relayout of the text view is triggered, which in turn leads to a relayout of views in an entire view tree related to the text view. For example, in an Android system, a TextView is a UI component corresponding to the text view, and a width, a height, or the like of the TextView are usually set to wrap_content, which means that the size of the TextView is automatically adjusted according to the text content. In this case, as long as a setText method is called to configure the text content, a requestLayout method is triggered regardless of whether the text content or size has changed. Triggering the requestLayout method causes the entire view tree where the TextView is located to be measured and laid out.

For a large application, the hierarchy and the number of views are generally large, and frequent triggering of a relayout under a complex layout will consume a large amount of system resources, which in turn will have a significant impact on the smoothness and power consumption of the user interface display.

In view of this, the present disclosure provides an information processing method. The method may obtain a to-be-displayed character string corresponding to a currently configured text view in a user interface, and automatically determine size information of the to-be-displayed character string. Further, whether to trigger a relayout of the text view is determined based on the size information of the to-be-displayed character string, size information of a character string displayed last time in the text view, and a size tolerance of the text view. This means that it is not necessary to trigger the relayout of the text view every time the content in the text view is configured, and the relayout of the text view may be dynamically controlled based on the size information of the character string and the size tolerance, so that the number of relayouts may be reduced, and the consumption of system resources may be reduced. Moreover, the measurement of the size of the to-be-displayed character string is simple, and the consumption of resources may also be reduced as compared with the measurement of the text view and other related views after the relayout is triggered. The information processing method of the present disclosure may improve the effective utilization of system resources, improve the smoothness of user interface display, and reduce power consumption, and is particularly effective for a user interface with a large view hierarchy and a large number of views and a complex layout.

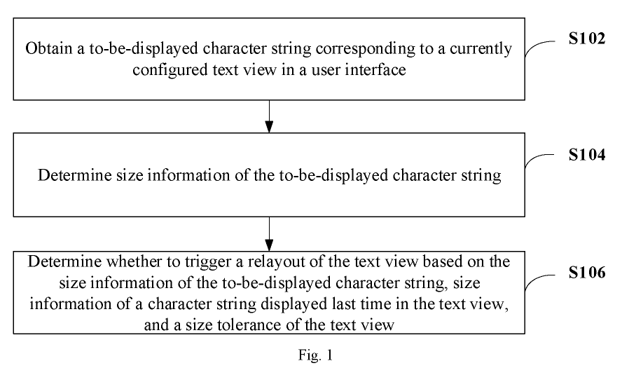

The information processing method of the present disclosure is described below with reference to FIGS. 1 to 3.

FIG. 1 is a flowchart of some embodiments of an information processing method of the present disclosure. As shown in FIG. 1, the method in this embodiment includes steps S102 to S106.

In step S102, a to-be-displayed character string corresponding to a currently configured text view in a user interface is obtained.

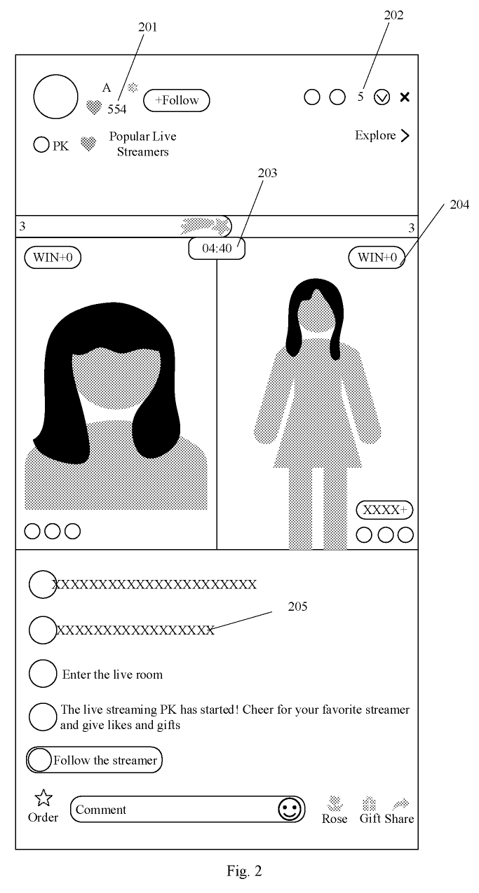

For example, the user interface is a live broadcast interface, an interactive live broadcast interface (which may also be referred to as a live broadcast PK, a live broadcast battle, or the like, where live streams of a plurality of users are co-streamed and displayed, and live pictures of the plurality of users may be simultaneously displayed on the live broadcast interface) participated in by a plurality of users, an activity display interface, or the like, which is not limited to the illustrated examples. The user interface may include one or more text views. For example, as shown in FIG. 2, the live broadcast PK interface may include a plurality of text views corresponding to the number of likes 201, the number of viewers 202, a countdown 203, scores 204, comment information 205, and the like. For example, the activity display interface may include a text view corresponding to a countdown of the activity.

Different text views may correspond to different update periods or update timings. When content (a character string) in a text view is updated, the to-be-displayed character string corresponding to the text view may be configured, to obtain the to-be-displayed character string. One or more text views may be currently configured. If a plurality of text views are currently configured, the method in this embodiment may be performed for each text view. The to-be-displayed character string may include one or more characters. The to-be-displayed character string may include one or more types of characters, such as numbers, Chinese, English, and the like, which is not limited to the illustrated examples.

In step 104, size information of the to-be-displayed character string is determined.

The size information of the to-be-displayed character string includes at least one of a width or a height of the to-be-displayed character string. In some embodiments, whether a display direction of the to-be-displayed character string and attribute information of characters have changed is determined, and size information corresponding to the display direction of the to-be-displayed character string is determined if the display direction of the to-be-displayed character string and the attribute information of the characters are unchanged. For example, if the display direction of the to-be-displayed character string is horizontal, the width of the to-be-displayed character string is determined, and if the display direction of the to-be-displayed character string is vertical, the height of the to-be-displayed character string is determined. The attribute information of the characters includes a font, a font size, a font weight, a character spacing, and the like. If the display direction of the to-be-displayed character string or the attribute information of the characters has changed, the width and the height of the to-be-displayed character string may be determined.

In step S106, whether to trigger a relayout of the text view is determined based on the size information of the to-be-displayed character string, size information of a character string displayed last time in the text view, and a size tolerance of the text view.

The size information of the character string displayed last time corresponds to the size information of the to-be-displayed character string, and may be used to determine whether the size of the character string in the text view has changed. The size tolerance of the text view is used to represent an allowable deviation between a currently determined size of the text view and a size of the text view automatically adjusted based on the size information of the to-be-displayed character string. For example, in the case where the attribute value of the size setting of the text view is wrap_content, the size of the text view automatically adjusted based on the size information of the to-be-displayed character string may be determined.

The size tolerance may be configured according to actual requirements. The higher the requirement for the size accuracy of the text view, the smaller the size tolerance may be set, and accordingly, the probability of triggering a relayout may be higher. The size tolerance includes at least one of a width tolerance or a height tolerance.

The information processing method in the above embodiment may obtain the to-be-displayed character string corresponding to the currently configured text view in the user interface, and automatically determine the size information of the to-be-displayed character string. Further, whether to trigger the relayout of the text view is determined based on the size information of the to-be-displayed character string, the size information of the character string displayed last time in the text view, and the size tolerance of the text view. This means that it is not necessary to trigger the relayout of the text view every time the content in the text view is configured, and the relayout of the text view may be dynamically controlled based on the size information of the character string and the size tolerance of the text view, so that the number of relayouts may be reduced, and the consumption of system resources may be reduced. Moreover, the measurement of the size of the to-be-displayed character string is simple, and the consumption of resources may also be reduced as compared with the measurement of the text view and other related views after the relayout is triggered. The information processing method in the above embodiment may improve the effective utilization of system resources, improve the smoothness of the user interface display, and reduce power consumption, and is particularly effective for a user interface with a large view hierarchy and a large number of views and a complex layout.

Specific methods of the steps of the information processing method are described below. How to obtain the to-be-displayed character string is first described below.

In some embodiments, in response to the text view calling a setText method to configure the to-be-displayed character string, the to-be-displayed character string is obtained from the setText method.

For example, for any TextView component, in a case where the component calls the setText method to configure the to-be-displayed character string, the to-be-displayed character string may be obtained by the setText method.

After the to-be-displayed character string is obtained, the to-be-displayed character string may be recognized to determine whether the to-be-displayed character string has changed (a change in characters or attribute information) as compared with the character string displayed last time; and the size information of the to-be-displayed character string is determined in response to the to-be-displayed character string having changed as compared with the character string displayed last time.

In some cases, the to-be-displayed character string does not change as compared with the character string displayed last time. For example, in a live broadcast scenario, the same user sends the same message a plurality of times, that is, the content in the corresponding text view does not change. If the to-be-displayed character string has not changed as compared with the character string displayed last time (both the characters and the attribute information are unchanged), there is no need to further measure the size of the to-be-displayed character string, and it may be directly determined that the relayout of the text view is not triggered, thereby further improving the determination efficiency and saving system resources.

How to determine the size information of the to-be-displayed character string is specifically described below.

In some embodiments, the to-be-displayed character string is segmented to obtain each character in the to-be-displayed character string; size information of each character is determined based on attribute information of each character; and the size information of the to-be-displayed character string is determined based on the size information of each character and a spacing between every two characters.

For example, the size information of the to-be-displayed character string in a specified paint (Paint) setting may be determined. The paint corresponds to the attribute information of the characters. For example, in the Android system, a Paint object contains various attributes for drawing a string, such as a font, a font size, a style (bold, italic, etc.), and the character spacing, that is, the spacing between every two characters, may also belong to the attribute information of the characters or the character string. A Paint.measureText method may be called to measure the width of each character, or the Paint.measureText method may be called to directly measure the width of the to-be-displayed character string. When a character or a character string is passed to the measureText method, the width occupied by the character string when drawn according to the current Paint setting is returned. For example, a paint.getTextBounds method may be called to determine the height of each character or the to-be-displayed character string.

Some fonts are fonts of equal width, that is, characters of the same type have equal widths, for example, Chinese characters have equal widths, and numeric characters have equal widths. In this case, one or more character types corresponding to the to-be-displayed character string, the number of characters of each character type, and the character size of each character type may be determined, and the size information of the to-be-displayed character string may be determined based on the number of characters of each character type and the character size of each character type.

To further improve the efficiency of determining the size information of the to-be-displayed character string, the size information of the characters may be stored in a cache. For example, for each character, whether there is size information of the character in the cache is searched for; and in response to there being no size information of the character in the cache, the size information of the character is determined based on the attribute information of the character, and the size information of the character is stored in the cache; or in response to there being the size information of the character in the cache, the size information of the character is obtained from the cache.

For each character, whether there is the size information of the character in the cache may be first searched for, and if not, the size information of the character is further determined based on the attribute information of the character, and the size information of the character is stored in the cache to facilitate subsequent searching, thereby improving the efficiency of determining the size information of the to-be-displayed character string and saving system resources.

In some embodiments, for each character, in response to the attribute information of the character having changed, the size information of the character in the cache is deleted, and the size information of the character is re-determined based on the attribute information of the character, and the re-determined size information of the character is stored in the cache.

For each character, if the attribute information of the character has changed, the size information of the character needs to be updated in the cache to improve the accuracy of subsequent determination of the size information of the to-be-displayed character string.

How to determine whether to trigger the relayout of the text view based on the size information of the to-be-displayed character string, the size information of the character string displayed last time in the text view, and the size tolerance of the text view is specifically described below.

In some embodiments, whether the size information of the to-be-displayed character string has changed with respect to the size information of the character string displayed last time is determined; and whether to trigger the relayout of the text view is determined based on the size tolerance of the text view in response to the size information of the to-be-displayed character string having changed with respect to the size information of the character string displayed last time.

The size information of the character string displayed last time may be cached, and that the size information of the to-be-displayed character string has changed with respect to the size information of the character string displayed last time may be determined by comparing the width of the to-be-displayed character string and the width of the character string displayed last time, and/or comparing the height of the to-be-displayed character string and the height of the character string displayed last time. For example, in a case where the text view is displayed horizontally and the attribute information of the to-be-displayed character string has not changed with respect to the attribute information of the character string displayed last time, it is possible to only compare the width of the to-be-displayed character string and the width of the character string displayed last time. For example, in a case where the text view is displayed vertically and the attribute information of the to-be-displayed character string has not changed with respect to the attribute information of the character string displayed last time, it is possible to only compare the height of the to-be-displayed character string and the height of the character string displayed last time.

Different size tolerances may correspond to different trigger conditions for the relayout. In a case where the size information of the to-be-displayed character string has changed with respect to the size information of the character string displayed last time, whether to trigger the relayout of the text view may be further determined based on the trigger condition corresponding to the size tolerance.

In some embodiments, in response to the size information of the to-be-displayed character string being unchanged with respect to the size information of the character string displayed last time, it is determined not to trigger the relayout of the text view.

Even if the to-be-displayed character string has changed with respect to the character string displayed last time, as long as the size information of the to-be-displayed character string is unchanged with respect to the size information of the character string displayed last time, there is no need to trigger the relayout of the text view, thereby reducing the number of relayouts, reducing the consumption of system resources, improving the utilization of system resources, improving the smoothness of the user interface display, and reducing power consumption.

If the attribute information of the to-be-displayed character string is unchanged with respect to the attribute information of the character string displayed last time, and characters of the same character type have equal sizes, it may be determined whether the character type(s) corresponding to the to-be-displayed character string is the same as the character type(s) corresponding to the character string displayed last time, and if they are the same, it is determined whether the number of characters of the to-be-displayed character string is the same with that of the character string displayed last time foreach character type, and if they are the same, it is determined that the size information of the to-be-displayed character string is unchanged with respect to the size information of the character string displayed last time, otherwise, it is determined that the size information of the to-be-displayed character string has changed with respect to the size information of the character string displayed last time. This may reduce the measurement of the size of the characters.

How to determine whether to trigger the relayout of the text view based on the size tolerance of the text view is specifically described below.

In some embodiments, in response to the size tolerance being zero, it is determined to trigger the relayout of the text view.

In the case where the size tolerance is zero, the trigger condition may include a condition that the size information of the to-be-displayed character string has changed with respect to the size information of the character string displayed last time. A size tolerance of zero means that the text view needs to precisely match the size of the to-be-displayed character string. Therefore, as long as the size information of the to-be-displayed character string changes with respect to the size information of the character string displayed last time, the relayout of the text view is triggered. This may adapt to a scenario with a high requirement for the display accuracy of the UI, and mainly reduce the number of relayouts triggered when the size of the character string is unchanged.

In a case where the size tolerance is not zero, a plurality of trigger conditions may be corresponded.

In some embodiments, in response to the size tolerance being not zero, whether the text view is capable of accommodating the to-be-displayed character string is determined based on the size information of the to-be-displayed character string and current size information of the text view; and in response to the text view being incapable of accommodating the to-be-displayed character string, it is determined to trigger the relayout of the text view.

A size tolerance means being not zero that a certain error is allowed between the currently determined size of the text view and the size of the text view automatically adjusted based on the size information of the to-be-displayed character string. In this case, the corresponding trigger condition may include a condition that the text view is unable to accommodate the to-be-displayed character string.

Determining whether the text view may accommodate the to-be-displayed character string may include determining whether a current width of the text view is greater than or equal to the width of the to-be-displayed character string, and/or determining whether a current height of the text view is greater than or equal to the height of the to-be-displayed character string. For example, in a case where the text view is displayed horizontally and the attribute information of the to-be-displayed character string has not changed with respect to the attribute information of the character string displayed last time, it may only be determined whether the current width of the text view is greater than or equal to the width of the to-be-displayed character string. If the current width of the text view is greater than or equal to the width of the to-be-displayed character string, and the current height of the text view is greater than or equal to the height of the to-be-displayed character string, it is determined that the text view may accommodate the to-be-displayed character string, otherwise, it is determined that the text view is unable to accommodate the to-be-displayed character string.

Since the size of the text view is slightly larger than the size of the to-be-displayed character string, it may be determined whether the current width of the text view is greater than or equal to a sum of the width of the to-be-displayed character string and a padding, and/or, it is determined whether the current height of the text view is greater than or equal to a sum of the height of the to-be-displayed character string and a padding. The padding in the width direction and the padding in the height direction may be different.

In the case where the size tolerance is not zero, determining whether to trigger the relayout by considering whether the text view may accommodate the to-be-displayed character string may ensure that the to-be-displayed character string may be accurately displayed while reducing the number of relayouts, thereby avoiding the situation of incomplete display.

In some embodiments, in response to the text view being capable of accommodating the to-be-displayed character string, a change value of the size information of the to-be-displayed character string with respect to the size information of the character string displayed last time is determined; in response to the change value being greater than the size tolerance, it is determined to trigger the relayout of the text view; and in response to the change value being less than or equal to the size tolerance, it is determined not to trigger the relayout of the text view.

The trigger condition for the relayout may further include a condition that the change value is greater than the size tolerance. The change value may be an absolute value. The change value includes at least one of a width change value or a height change value, and the size tolerance includes at least one of a width tolerance or a height tolerance, which specifically depends on whether the size information of the to-be-displayed character string and the size information of the character string displayed last time contain the width or the height. For example, in response to the width change value being greater than the width tolerance, or the height change value being greater than the height tolerance, it is determined to trigger the relayout of the text view; and in response to the width change value being less than or equal to the width tolerance, and the height change value being less than or equal to the height tolerance, it is determined not to trigger the relayout of the text view.

Determining whether the deviation of the text view is within the size tolerance directly by using the change value of the to-be-displayed character string with respect to the character string displayed last time may simplify the comparison process, thereby improving the efficiency of determining whether to trigger the relayout.

The method in the above embodiment may be applied to a scenario where a certain error is allowed in the UI display accuracy, may ensure the complete display of the to-be-displayed character string within the size tolerance, and may more effectively reduce the number of relayouts triggered, improve the effective utilization of system resources, improve the smoothness of the user interface display, and reduce power consumption.

In many cases, characters of the same type do not differ much in size, for example, the numbers 0 to 9 do not differ much with each other in width. In view of this feature, in the case where the size tolerance is not zero, the following method may also be used to determine whether to trigger the relayout of the text view.

In some embodiments, in response to the size tolerance being not zero, one or more character types corresponding to the to-be-displayed character string and one or more character types of the character string displayed last time are recognized; and in response to the one or more character types corresponding to the to-be-displayed character string being partially or completely different from the one or more character types of the character string displayed last time, it is determined to trigger the relayout of the text view.

The trigger condition for the relayout may include a condition that the character types of the to-be-displayed character string and the character types of the character string displayed last time are different. For example, the character types corresponding to the to-be-displayed character string are Chinese and numbers, and the character types corresponding to the character string displayed last time are English and numbers. The Chinese characters differ greatly in size from the English characters, and therefore, to avoid that the to-be-displayed character string cannot be completely displayed and improve the accuracy of the layout, it is determined to trigger the relayout of the text view.

In some embodiments, in response to the one or more character types corresponding to the to-be-displayed character string being completely the same as the one or more character types of the character string displayed last time; for each character type, whether the number of characters corresponding to the character type in the to-be-displayed character string is the same as the number of characters corresponding to the character type in the character string displayed last time is determined; in response to there being a case where the numbers of characters of the same character type in the to-be-displayed character string and the character string displayed last time are different, it is determined to trigger the relayout of the text view; and in response to the numbers of characters of the same character type in the to-be-displayed character string and the character string displayed last time being the same, it is determined not to trigger the relayout of the text view.

The trigger condition for the relayout may further include a condition that the numbers of characters of the same character type in the to-be-displayed character string and the character string displayed last time are different. If the character types of the to-be-displayed character string and the character string displayed last time are completely the same, it may be determined whether the numbers of characters of each character type in the to-be-displayed character string and the character string displayed last time are the same, and if they are the same, it is determined that the size of the to-be-displayed character string has little change with respect to the size of the character string displayed last time, and the size tolerance is satisfied, and there is no need to trigger the relayout, otherwise, the relayout needs to be triggered.

The method in the above embodiment may be applied to a scenario where a certain error is allowed in the UI display accuracy, and by matching the character types and the number of characters, the complete display of the to-be-displayed character string may be ensured within the size tolerance, and the number of relayouts triggered may be more effectively reduced, the effective utilization of system resources may be improved, the smoothness of the user interface display may be improved, and power consumption may be reduced.

Characters of some character types may differ greatly in size. To further improve the accuracy of the layout, the one or more character types may be one or more specific character types, and the maximum difference in size between characters of each specific character type does not exceed a preset value. The maximum difference includes at least one of a width difference or a height difference, and the preset value also includes at least one of a preset width value or a preset height value. That is, in the above embodiment, if the to-be-displayed character string and the character string displayed last time only include the the one or more specific character types, whether to trigger the relayout of the text view may be determined according to the method in the above embodiment.

If the to-be-displayed character string and the character string displayed last time further include character types other than the one or more specific character types, the following method may be used to determine whether to trigger the relayout of the text view.

In some embodiments, in response to the size tolerance being not zero, one or more specific character types that are the same in the to-be-displayed character string and the character string displayed last time are recognized; in response to there being no one or more specific character types that are the same in the to-be-displayed character string and the character string displayed last time, it is determined to trigger the relayout of the text view; in response to there being one or more specific character types that are the same in the to-be-displayed character string and the character string displayed last time, first size information of characters other than characters of the one or more specific character types in the to-be-displayed character string and second size information of characters other than the characters of the one or more specific character types in the character string displayed last time are determined; and in response to the first size information being different from the second size information, it is determined to trigger the relayout of the text view.

The trigger condition for the relayout may include a condition that there is no one or more specific character types that are the same in the to-be-displayed character string and the character string displayed last time, and a condition that the first size information is different from the second size information.

For example, the to-be-displayed character string and the character string displayed last time both include the specific character type of numbers. Then, the first size information and the second size information of the characters other than the characters of the number type are determined. It may also be directly determined whether the characters other than the specific character type in the to-be-displayed character string and the character string displayed last time are the same, and if the other characters are the same, it is determined that the first size information and the second size information are the same, and if the other characters are different, it is determined whether the first size information and the second size information are the same.

In some embodiments, in response to the first size information being the same as the second size information, for each of the one or more specific character types, whether a number of characters of the specific character type in the to-be-displayed character string is the same as a number of characters of the specific character type in the character string displayed last time is determined; in response to there being a case where the numbers of characters of the same specific character type in the to-be-displayed character string and the character string displayed last timeare different, it is determined to trigger the relayout of the text view; and in response to the numbers of characters of the same specific character type in the to-be-displayed character string and the character string displayed last time being the same, it is determined not to trigger the relayout of the text view.

The trigger condition for the relayout includes a condition that there is a difference in the numbers of characters of the same specific character type in the to-be-displayed character string and the character string displayed last time. If the first size information and the second size information are the same, and the numbers of characters of the same specific character type in the to-be-displayed character string and the character string displayed last time are the same, it indicates that the change in the text view is within the scope of the size tolerance, and there is no need to trigger the relayout.

In response to the numbers of characters of the same specific character type in the to-be-displayed character string and the character string displayed last time being the same, it is also possible to determine the total number of characters of the one or more specific character types, and in response to the total number being less than or equal to a number threshold, it is determined not to trigger the relayout of the text view. In response to the total number being greater than the number threshold, it is determined to trigger the relayout of the text view. If the total number is too large, the to-be-displayed character string may differ greatly in size from the character string displayed last time, and the relayout of the text view may be triggered. The size tolerance may be set to the product of the maximum difference in size between characters of the specific character type and the number threshold.

When setting the size of the text view, it is possible to determine the product of the maximum size of characters of the specific character type and the number of characters of the specific character type, and set the size of the text view according to the sum of the size information of the characters other than the characters of the specific character type and the product, so that if only the characters of the specific character type change later, the number of relayouts may be reduced as long as the number of characters is unchanged.

For example, for the text view corresponding to the number of likes, if the character string changes from "100 likes" to "999 likes", 899 relayouts need to be triggered if a relayout needs to be triggered for each change in the value, and no relayout needs to be triggered according to the above method.

The method in the above embodiment is applicable to a scenario where characters of the specific character type change frequently, and a certain error is allowed in the UI display accuracy. The method may ensure the complete display of the to-be-displayed character string within the size tolerance, and may more effectively reduce the number of relayouts triggered, improve the effective utilization of system resources, improve the smoothness of the user interface display, and reduce power consumption.

In the case where the size tolerance is not zero, a plurality of methods for determining whether to trigger the relayout may be combined with each other. For example, if there are one or more specific character types that are the same in the to-be-displayed character string and the character string displayed last time, it may be determined whether the first size information and the second size information are the same, and if the first size information and the second size information are different, the change value of the size information of the to-be-displayed character string with respect to the size information of the character string displayed last time may be determined; in response to the change value being greater than the size tolerance, it is determined to trigger the relayout of the text view; and in response to the change value being less than or equal to the size tolerance, it is determined not to trigger the relayout of the text view. If the first size information and the second size information are the same, it is determined, for each specific character type, whether the number of characters of the specific character type in the to-be-displayed character string is the same as the number of characters of the specific character type in the character string displayed last time, and in response to there being a case where the numbers of characters of the same specific character type in the to-be-displayed character string and the character string displayed last time are different, it is determined to trigger the relayout of the text view; and in response to the numbers of characters of the same specific character type in the to-be-displayed character string and the character string displayed last time being the same, it is determined not to trigger the relayout of the text view.

If it is determined to trigger the relayout of the text view, since the size information of the to-be-displayed character string has been measured, the size information may be used for the relayout.

In some embodiments, in response to determining to trigger the relayout of the text view, size information of the text view is re-determined based on the size information of the to-be-displayed character string and a position parameter of the to-be-displayed character string in the text view; the configured size information of the text view is updated with the re-determined size information; and the relayout of the text view is triggered based on the updated size information of the text view, where an attribute of the updated size information is configured as a fixed value.

For example, the size information of the TextView may be set to the re-determined size information by LayoutParams and used as the fixed value. Subsequently, the relayout is performed according to the re-determined size information, and there is no need to perform measurement again, thereby saving system resources.

In some embodiments, for the text view, a relayout method is called to relayout the text view based on the set updated size information of the text view, a view tree related to the text view, and layout parameters of other views in the view tree.

For example, the requestLayout method is called to relayout the text view and the other views in the view tree based on the set updated size information of the text view, the view tree related to the text view, and the layout parameters of the other views in the view tree.

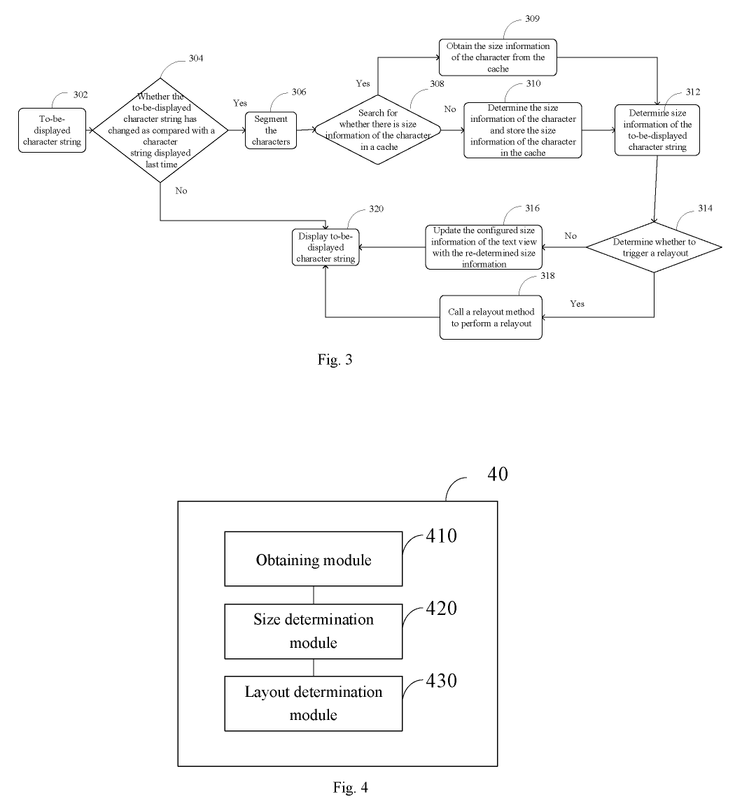

The information processing method of the present disclosure is described below with reference to FIG. 3.

FIG. 3 is a flowchart of some embodiments of an information processing method of the present disclosure. As shown in FIG. 3, the method in this embodiment includes steps S302 to S320.

In step S302, a to-be-displayed character string corresponding to a currently configured text view in a user interface is obtained.

In step S304, the to-be-displayed character string is recognized to determine whether the to-be-displayed character string has changed as compared with a character string displayed last time. If it has not changed, step S320 is executed, otherwise, step S306 is executed.

In step S306, the to-be-displayed character string is segmented to obtain characters in the to-be-displayed character string.

In step S308, for each character, whether there is size information of the character in a cache is searched for. If there is, step S309 is executed, and otherwise, step S310 is executed.

In step S309, the size information of the character is obtained from the cache.

In step S310, the size information of the character is determined based on attribute information of the character, and the size information of the character is stored in the cache.

In step S312, size information of the to-be-displayed character string is determined based on the size information of each character and a spacing between every two characters.

In step S314, whether to trigger a relayout of the text view is determined based on the size information of the to-be-displayed character string, size information of a character string displayed last time in the text view, and a size tolerance of the text view. If yes, step S316 is executed, and otherwise, step S320 is executed.

In step S316, size information of the text view is re-determined based on the size information of the to-be-displayed character string, and the configured size information of the text view is updated with the re-determined size information.

In step S318, a relayout method is called to perform a relayout.

In step S320, the to-be-displayed character string is displayed.

The super.setText method may be called to display the to-be-displayed character string. For the system update process of the super.setText method, reference may be made to the prior art, and details are not described herein again.

The information processing method of the present disclosure may be performed by a client. By taking over the system measurement process and determining whether to trigger the relayout, it may be avoided to re-measure and re-layout every time after the text is updated. When applied to the live broadcast scenario, since the number of relayouts is greatly reduced, the live broadcast frame rate may be effectively improved, the frame drop rate may be reduced, power consumption may be reduced, device heating may be reduced, and the smoothness of image display may be improved.

The present disclosure further provides an information processing apparatus, which is described below with reference to FIG. 4.

FIG. 4 is a structural diagram of some embodiments of an information processing apparatus of the present disclosure. As shown in FIG. 4, the information processing apparatus 40 in this embodiment includes: an obtaining module 410, a size determination module 420, and a layout determination module 430.

The obtaining module 410 is configured to obtain a to-be-displayed character string corresponding to a currently configured text view in a user interface.

The size determination module 420 is configured to determine size information of the to-be-displayed character string.

The layout determination module 430 is configured to determine whether to trigger a relayout of the text view based on the size information of the to-be-displayed character string, size information of a character string displayed last time in the text view, and a size tolerance of the text view.

In some embodiments, the layout determination module 430 is configured to determine whether the size information of the to-be-displayed character string has changed with respect to the size information of the character string displayed last time; and determine whether to trigger the relayout of the text view based on the size tolerance of the text view in response to the size information of the to-be-displayed character string having changed with respect to the size information of the character string displayed last time.

In some embodiments, the layout determination module 430 is configured to determine to trigger the relayout of the text view in response to the size tolerance being zero.

In some embodiments, the layout determination module 430 is configured to: in response to the size tolerance being not zero, determine, based on the size information of the to-be-displayed character string and current size information of the text view, whether the text view is capable of accommodating the to-be-displayed character string; and determine to trigger the relayout of the text view in response to the text view being incapable of accommodating the to-be-displayed character string.

In some embodiments, the layout determination module 430 is configured to: in response to the text view being capable of accommodating the to-be-displayed character string, determine a change value of the size information of the to-be-displayed character string with respect to the size information of the character string displayed last time; determine to trigger the relayout of the text view in response to the change value being greater than the size tolerance; and determine not to trigger the relayout of the text view in response to the change value being less than or equal to the size tolerance.

In some embodiments, the layout determination module 430 is configured to: in response to the size tolerance being not zero, recognize one or more specific character types that are the same in the to-be-displayed character string and the character string displayed last time; determine to trigger the relayout of the text view in response to there being no one or more specific character types that are the same in the to-be-displayed character string and the character string displayed last time; determine first size information of characters other than characters of the one or more specific character types in the to-be-displayed character string and second size information of characters other than the characters of the one or more specific character types in the character string displayed last time in response to there being the one or more specific character types that are the same in the to-be-displayed character string and the character string displayed last time; and determine to trigger the relayout of the text view in response to the first size information being different from the second size information.

In some embodiments, the layout determination module 430 is further configured to: in response to the first size information being the same as the second size information, determine, for each of the one or more specific character types, whether a number of characters of the specific character type in the to-be-displayed character string is the same as a number of characters of the specific character type in the character string displayed last time; determine to trigger the relayout of the text view, in response to there being a case where the numbers of characters of the same specific character type in the to-be-displayed character string and the character string displayed last time are different; and determine not to trigger the relayout of the text view, in response to the numbers of characters of the same specific character type in the to-be-displayed character string and the character string displayed last time being the same.

In some embodiments, the layout determination module 430 is further configured to determine not to trigger the relayout of the text view in response to the size information of the to-be-displayed character string having not changed with respect to the size information of the character string displayed last time.

In some embodiments, the size determination module 420 is configured to recognize the to-be-displayed character string to determine whether the to-be-displayed character string has changed with respect to the character string displayed last time; and determine the size information of the to-be-displayed character string in response to the to-be-displayed character string having changed with respect to the character string displayed last time.

In some embodiments, the size determination module 420 is configured to segment the to-be-displayed character string to obtain characters in the to-be-displayed character string; determine size information of each character based on attribute information of each character; and determine the size information of the to-be-displayed character string based on the size information of each character and a spacing between every two characters.

In some embodiments, the size determination module 420 is configured to: for each character, search for whether there is size information of the character in a cache; and in response to there being no size information of the character in the cache, determine the size information of the character based on the attribute information of the character, and store the size information of the character in the cache; and in response to there being the size information of the character in the cache, obtain the size information of the character from the cache.

In some embodiments, the layout determination module 430 is further configured to: in response to determining to trigger the relayout of the text view, re-determine size information of the text view based on the size information of the to-be-displayed character string and a position parameter of the to-be-displayed character string in the text view; update the configured size information of the text view with the re-determined size information; and trigger the relayout of the text view based on the updated size information of the text view, wherein an attribute of the updated size information is configured as a fixed value.

In some embodiments, the layout determination module 430 is further configured to: for the text view, call a relayout method to relayout the text view based on the set updated size information of the text view, a view tree related to the text view, and layout parameters of other views in the view tree.

In some embodiments, the user interface includes a live broadcast interface, and the live broadcast interface includes one or more text views.

In some embodiments, the obtaining module 410 is configured to: in response to the text view calling a setText method to configure the to-be-displayed character string, obtain the to-be-displayed character string from the setText method.

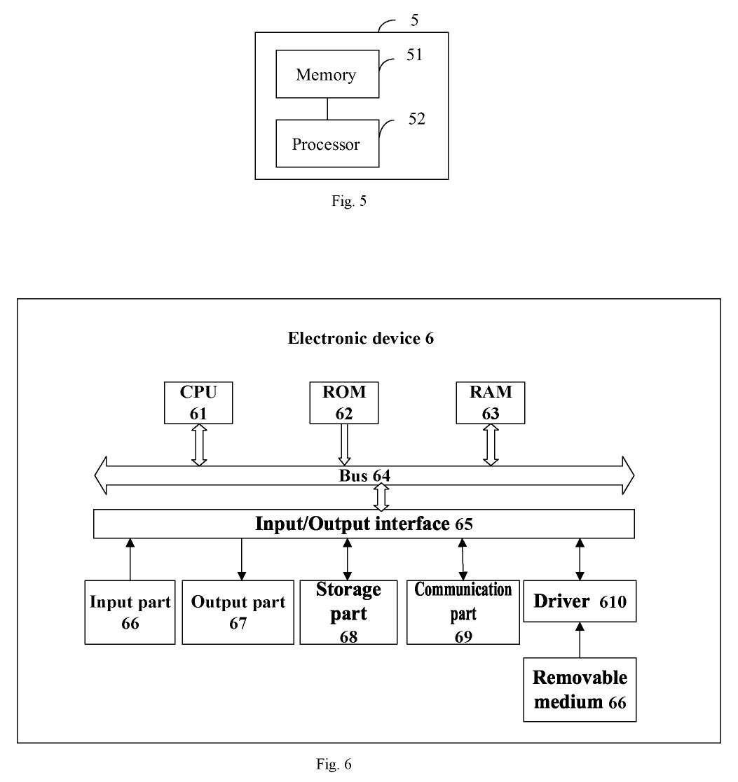

FIG. 5 is a block diagram of an electronic device according to some embodiments of the present disclosure.

The memory 51 is used to store one or more computer-readable instructions. The memory 51 may include any combination of various forms of computer-readable storage media, such as a volatile memory and/or a non-volatile memory, including but not limited to a random access memory (RAM), a dynamic random access memory (DRAM), a static random access memory (SRAM), a read-only memory (ROM), and a flash memory. The memory 51 may store, for example, an operating system, an application, a boot loader (Boot Loader), a database, and other programs, and may also store various applications, various data, and the like.

The processor 52 is used to run the computer-readable instructions to implement the information processing method according to any one of the embodiments. For the specific implementation of each step of the method, reference may be made to the above embodiments, and details of the same parts are not described herein again.

The processor 52 may be configured to perform the steps in FIGS. 1 and 3. The processor 52 may be embodied as various processing apparatuses, such as a central processing unit (CPU) and a network processor (NP); and may also be a digital signal processor (DSP), an application specific integrated circuit (ASIC), a field programmable gate array (FPGA) or other programmable logic devices, a discrete gate or transistor logic device, or a discrete hardware component. The central processing unit (CPU) may have an X86 or ARM architecture or the like.

The processor 52 and the memory 51 may directly or indirectly communicate with each other. For example, the processor 52 and the memory 51 may communicate through a network. The network may include a wireless network, a wired network, and/or any combination of a wireless network and a wired network. The processor 52 and the memory 51 may also communicate with each other through a system bus, which is not limited in the present disclosure.

It should be noted that the components of the electronic device 5 shown in FIG. 5 are merely exemplary and non-restrictive, and the electronic device 5 may further have other components according to actual application requirements. The processor 52 may control other components in the electronic device 5 to perform desired functions.

The electronic device 5 may be implemented by software, firmware, and/or hardware, and may be integrated in an apparatus in which a related application is installed.

FIG. 6 is a block diagram of an electronic device according to some other embodiments of the present disclosure.

The electronic device 6 shown in FIG. 6 may be a computer system having a dedicated hardware structure, and may perform corresponding functions when a related application is installed.

The electronic device includes, but is not limited to, mobile terminals such as a smartphone, a notebook computer, a personal digital assistant (PDA), a tablet computer (Tablet PC), a portable media player (PMP), a vehicle-mounted terminal (e.g., a vehicle navigation terminal), and a wearable device, and fixed terminals such as a digital television and a desktop computer.

As shown in FIG. 6, a central processing unit (CPU) 61 performs various processes based on a program stored in a read-only memory (ROM) 62 or a program loaded from a storage unit 68 into a random access memory (RAM) 63. The RAM 63 stores data required when the CPU 61 performs the various processes as needed. The central processing unit is merely exemplary, and it may be another type of processor, such as the various processors described above. The ROM 62, the RAM 63, and the storage unit 68 may be various forms of computer-readable storage media. It should be noted that although the ROM 62, the RAM 63, and the storage unit 68 are shown separately in FIG. 6, one or more of them may be combined or located in the same or different memories or storage modules.

The CPU 61, the ROM 62, and the RAM 63 are connected to each other via a bus 64. An input/output interface 65 is also connected to the bus 64.

The following components are connected to the input/output interface 65: an input unit 66, such as a touch screen, a touchpad, a keyboard, a mouse, an image sensor, a microphone, an accelerometer, and a gyroscope; an output unit 67, including a display, such as a cathode ray tube (CRT) and a liquid crystal display (LCD), a speaker, a vibrator, and the like; the storage unit 68, including a hard disk, a magnetic tape, and the like; and a communication unit 69, including a network interface card, such as a LAN card and a modem. The communication unit 69 allows communication processing to be performed via a network such as the Internet. It is easily understood that although the components in the electronic device 6 are shown in FIG. 6 to communicate through the bus 64, they may also communicate through a network or other means, where the network may include a wireless network, a wired network, and/or any combination of a wireless network and a wired network.

If necessary, a driver 610 is also connected to the input/output interface 65. A removable medium 611, such as a magnetic disk, an optical disc, a magneto-optical disc, and a semiconductor memory, is mounted on the driver 610 as needed, so that a computer program read therefrom is installed in the storage unit 68 as needed.

In the case where the above series of processes are implemented by software, a program that constitutes the software may be installed from a network such as the Internet or a storage medium such as the removable medium 611.

According to the embodiments of the present disclosure, the process described above with reference to the flowchart may be implemented as a computer software program. For example, some embodiments of the present disclosure include a computer program product that, when running on a computer, causes the computer to implement the method according to any one of the embodiments. The computer program product includes computer instructions carried on a computer-readable medium, and includes program code for performing the method shown in the flowchart. In such an embodiment, the computer instructions may be downloaded from a network and installed through the communication unit 69, or installed from the storage unit 68, or installed from the ROM 62. When the computer program is executed by the CPU 61, the method of the embodiments of the present disclosure is executed.

It should be noted that in the context of the present disclosure, the computer-readable medium may be a tangible medium that may include or store a program for use by or in combination with an instruction execution system, apparatus, or device.

The computer-readable medium may be a computer-readable storage medium, a computer-readable signal medium, or any combination thereof.

The computer-readable storage medium includes but is not limited to an electrical, magnetic, optical, electromagnetic, infrared, or semiconductor system, apparatus, or device, or any suitable combination thereof. More specific examples of the computer-readable storage medium may include but are not limited to: an electrical connection having one or more wires, a portable computer magnetic disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination thereof. In the present disclosure, the computer-readable storage medium may be any tangible medium that includes or stores a program, and the program may be used by or in combination with an instruction execution system, apparatus, or device. The computer-readable storage medium has computer instructions stored thereon, and the instructions, when executed by the processor, cause the method according to any one of the embodiments to be implemented.

The computer-readable signal medium may include a data signal propagated on a baseband or as a part of a carrier, and computer-readable program code is carried therein. The data signal propagated in this manner may be in multiple forms, and includes but is not limited to an electromagnetic signal, an optical signal, or any suitable combination thereof. The computer-readable signal medium may also be any computer-readable medium other than the computer-readable storage medium, and the computer-readable signal medium may send, propagate, or transmit a program used by or in combination with an instruction execution system, apparatus, or device. The program code contained on the computer-readable medium may be transmitted by any suitable medium, including but not limited to a wire, an optical cable, an RF (radio frequency), or any suitable combination thereof.

The above computer-readable medium may be included in the above electronic device, or may exist alone without being assembled into the electronic device.

In some embodiments, a computer program is further provided, including: instructions that, when executed by a processor, cause the processor to perform the method according to any one of the embodiments. For example, the instructions may be embodied as computer program code.

In the embodiments of the present disclosure, the computer program code for performing the operations of the present disclosure may be written in one or more programming languages or a combination thereof, where the programming languages include but are not limited to object-oriented programming languages, such as Java, Smalltalk, and C++, and further include conventional procedural programming languages, such as "C" language or similar programming languages. The program code may be completely executed on a computer of a user, partially executed on a computer of a user, executed as an independent software package, partially executed on a computer of a user and partially executed on a remote computer, or completely executed on a remote computer or server. In the case involving a remote computer, the remote computer may be connected to a computer of a user through any kind of network, including a local area network (LAN) or a wide area network (WAN), or may be connected to an external computer (for example, connected through the Internet with the aid of an Internet service provider).

The flowchart and block diagram in the drawings illustrate the possibly implemented architectures, functions, and operations of the system, the method, and the computer program product according to various embodiments of the present disclosure. In this regard, each block in the flowchart or block diagram may represent a module, program segment, or part of code, and the module, program segment, or part of code contains one or more executable instructions for implementing the specified logical functions. It should also be noted that, in some alternative implementations, the functions marked in the blocks may also occur in an order different from that marked in the drawings. For example, two blocks shown in succession may actually be performed substantially in parallel, or they may sometimes be performed in the reverse order, depending on the functions involved. It should also be noted that each block in the block diagram and/or the flowchart, and a combination of the blocks in the block diagram and/or the flowchart may be implemented by a dedicated hardware-based system that executes specified functions or operations, or may be implemented by a combination of dedicated hardware and computer instructions.

The functions described above may be at least partially performed by one or more hardware logic components. For example, without limitation, exemplary hardware logic components that may be used include: a field programmable gate array (FPGA), an application specific integrated circuit (ASIC), an application specific standard product (ASSP), a system on chip (SOC), a complex programmable logical device (CPLD), and the like.

Although some specific embodiments of the present disclosure have been described in detail by way of examples, those skilled in the art should understand that the above examples are only for illustration, and are not intended to limit the scope of the present disclosure. Those skilled in the art should understand that the above embodiments may be modified without departing from the scope and spirit of the present disclosure. The scope of the present disclosure is defined by the appended claims.

What is claimed is:

1. An information processing method, comprising:
obtaining a to-be-displayed character string corresponding to a currently configured text view in a user interface;
determining size information of the to-be-displayed character string; and
determining whether to trigger a relayout of the text view based on the size information of the to-be-displayed character string, size information of a character string displayed last time in the text view, and a size tolerance of the text view.

2. The information processing method of claim 1, wherein the determining whether to trigger the relayout of the text view based on the size information of the to-be-displayed character string, the size information of the character string displayed last time in the text view, and the size tolerance of the text view comprises:
determining whether the size information of the to-be-displayed character string has changed with respect to the size information of the character string displayed last time; and
determining whether to trigger the relayout of the text view based on the size tolerance of the text view in response to the size information of the to-be-displayed character string having changed with respect to the size information of the character string displayed last time.

3. The information processing method of claim 2, wherein the determining whether to trigger the relayout of the text view based on the size tolerance of the text view comprises:
determining to trigger the relayout of the text view in response to the size tolerance being zero.

4. The information processing method of claim 2, wherein the determining whether to trigger the relayout of the text view based on the size tolerance of the text view comprises:
determining, based on the size information of the to-be-displayed character string and current size information of the text view, whether the text view is capable of accommodating the to-be-displayed character string, in response to the size tolerance being not zero; and
determining to trigger the relayout of the text view, in response to the text view being incapable of accommodating the to-be-displayed character string.

5. The information processing method of claim 4, wherein the determining whether to trigger the relayout of the text view based on the size tolerance of the text view comprises:
determining a change value of the size information of the to-be-displayed character string with respect to the size information of the character string displayed last time in response to the text view being capable of accommodating the to-be-displayed character string;
determining to trigger the relayout of the text view in response to the change value being greater than the size tolerance; and
determining not to trigger the relayout of the text view in response to the change value being less than or equal to the size tolerance.

6. The information processing method of claim 2, wherein the determining whether to trigger the relayout of the text view based on the size tolerance of the text view comprises:
recognizing one or more specific character types that are the same in the to-be-displayed character string and the character string displayed last time, in response to the size tolerance being not zero;
determining to trigger the relayout of the text view in response to there being no one or more specific character types that are the same in the to-be-displayed character string and the character string displayed last time;
determining first size information of characters other than characters of the one or more specific character types in the to-be-displayed character string and second size information of characters other than the characters of the one or more specific character types in the character string displayed last time, in response to there being the one or more specific character types that are the same in the to-be-displayed character string and the character string displayed last time; and
determining to trigger the relayout of the text view in response to the first size information being different from the second size information.

7. The information processing method of claim 6, wherein the determining whether to trigger the relayout of the text view based on the size tolerance of the text view further comprises:
determining, for each of the one or more specific character types, whether a number of characters of the specific character type in the to-be-displayed character string is the same as a number of characters of the specific character type in the character string displayed last time, in response to the first size information being the same as the second size information;
determining to trigger the relayout of the text view, in response to there being a case where the numbers of characters of the same specific character type in the to-be-displayed character string and the character string displayed last time are different; and
determining not to trigger the relayout of the text view, in response to the numbers of characters of the same specific character type in the to-be-displayed character string and the character string displayed last time being the same.

8. The information processing method of claim 2, wherein the determining whether to trigger the relayout of the text view based on the size information of the to-be-displayed character string, the size information of the character string displayed last time in the text view, and the size tolerance of the text view further comprises:
determining not to trigger the relayout of the text view in response to the size information of the to-be-displayed character string having not changed with respect to the size information of the character string displayed last time.

9. The information processing method of claim 1, wherein the determining the size information of the to-be-displayed character string comprises:
recognizing the to-be-displayed character string to determine whether the to-be-displayed character string has changed with respect to the character string displayed last time; and
determining the size information of the to-be-displayed character string in response to the to-be-displayed character string having changed with respect to the character string displayed last time.

10. The information processing method of claim 1, wherein the determining the size information of the to-be-displayed character string comprises:
segmenting the to-be-displayed character string to obtain characters in the to-be-displayed character string;
determining size information of each character based on attribute information of each character; and
determining the size information of the to-be-displayed character string based on the size information of each character and a spacing between every two characters.

11. The information processing method of claim 10, wherein the determining the size information of each character based on the attribute information of each character comprises, for each character:
searching for whether there is size information of the character in a cache;
determining the size information of the character based on the attribute information of the character, and storing the size information of the character in the cache, in response to there being no size information of the character in the cache; and
obtaining the size information of the character from the cache, in response to there being the size information of the character in the cache.

12. The information processing method of claim 1, further comprising:
re-determining size information of the text view based on the size information of the to-be-displayed character string and a position parameter of the to-be-displayed character string in the text view, in response to determining to trigger the relayout of the text view;
updating the configured size information of the text view with the re-determined size information; and
triggering the relayout of the text view based on the updated size information of the text view, wherein an attribute of the updated size information is configured as a fixed value.

13. The information processing method of claim 12, wherein the triggering the relayout of the text view based on the updated size information of the text view comprises:
calling a relayout method for the text view to relayout the text view based on the configured updated size information of the text view, a view tree related to the text view, and layout parameters of other views in the view tree, to relayout the text view.

14. The information processing method of claim 1, wherein the user interface comprises a live broadcast interface, the live broadcast interface comprises one or more text views, and the obtaining the to-be-displayed character string corresponding to the currently configured text view in the user interface comprises:
obtaining the to-be-displayed character string from a set text method, in response to the text view calling the set text method to configure the to-be-displayed character string.

15. An electronic device, comprising:
one or more processors; and
one or more memories coupled to the one or more processors and configured to store instructions, wherein the instructions, when executed by the one or more processors cause the one or more processors to:
obtain a to-be-displayed character string corresponding to a currently configured text view in a user interface;
determine size information of the to-be-displayed character string; and
determine whether to trigger a relayout of the text view based on the size information of the to-be-displayed character string, size information of a character string displayed last time in the text view, and a size tolerance of the text view.

16. The electronic device according to claim 15, wherein the determining whether to trigger the relayout of the text view based on the size information of the to-be-displayed character string, the size information of the character string displayed last time in the text view, and the size tolerance of the text view comprises:
determining whether the size information of the to-be-displayed character string has changed with respect to the size information of the character string displayed last time; and
determining whether to trigger the relayout of the text view based on the size tolerance of the text view in response to the size information of the to-be-displayed character string having changed with respect to the size information of the character string displayed last time.

17. The electronic device according to claim 16, wherein the determining whether to trigger the relayout of the text view based on the size tolerance of the text view comprises:
determining to trigger the relayout of the text view in response to the size tolerance being zero.

18. A non-transitory computer-readable storage medium having a computer program stored thereon, wherein the computer program, when executed by a processor, causes the processor to:
obtain a to-be-displayed character string corresponding to a currently configured text view in a user interface;
determine size information of the to-be-displayed character string; and
determine whether to trigger a relayout of the text view based on the size information of the to-be-displayed character string, size information of a character string displayed last time in the text view, and a size tolerance of the text view.

19. The non-transitory computer-readable storage medium of claim 18, wherein the determining whether to trigger the relayout of the text view based on the size information of the to-be-displayed character string, the size information of the character string displayed last time in the text view, and the size tolerance of the text view comprises:
determining whether the size information of the to-be-displayed character string has changed with respect to the size information of the character string displayed last time; and
determining whether to trigger the relayout of the text view based on the size tolerance of the text view in response to the size information of the to-be-displayed character string having changed with respect to the size information of the character string displayed last time.

20. The non-transitory computer-readable storage medium of claim 18, wherein the determining whether to trigger the relayout of the text view based on the size tolerance of the text view comprises:
determining to trigger the relayout of the text view in response to the size tolerance being zero.
